(19) United States
(12) Patent Application Publication
(10) Pub. No.: US 2025/0140501 A1
(43) Pub. Date: May 1, 2025

(54) PUSH ROD ASSEMBLY, MANUFACTURING METHOD THEREOF AND RELAY

(71) Applicant: Xiamen Hongfa Electric Power Controls Co., Ltd., Xiamen (CN)

(72) Inventors: Fengzhu XIE, Xiamen (CN); Wenguang DAI, Xiamen (CN)

(21) Appl. No.: 18/925,995

(22) Filed: Oct. 24, 2024

(30) Foreign Application Priority Data
Oct. 25, 2023 (CN) 2023113945037

(51) Int. Cl. H01H 50/64; H01H 49/00; H01H 50/02; H01H 50/54; H01H 50/58

(52) U.S. Cl. CPC H01H 50/641; H01H 49/00; H01H 50/02; H01H 50/541; H01H 50/58; H01H 2050/028

(57) ABSTRACT

The present disclosure relates to the technical field of electronic control devices, specifically to a push rod assembly, a manufacturing method thereof and a relay. The push rod assembly includes a push rod, an auxiliary movable contact part and an isolation cover. The auxiliary movable contact part includes an auxiliary movable contact piece and an auxiliary movable contact provided on an end portion of the auxiliary movable contact piece. The isolation cover is connected to the push rod and the auxiliary movable contact piece, so as to follow the push rod. The isolation cover covers the auxiliary movable contact to isolate the auxiliary movable contact from a main movable contact part. The isolation cover is configured to extend a creepage distance from the main movable contact part to the auxiliary movable contact part.

### CROSS REFERENCE

This application is based upon and claims priority to Chinese Patent Application No. 2023113945037, filed on Oct. 25, 2023, the entire contents thereof are incorporated herein by reference.

### TECHNICAL FIELD

The present disclosure relates to the technical field of electronic control devices, specifically to a push rod assembly, a manufacturing method thereof and a relay.

### BACKGROUND

A relay is an electronic control device that has a control system (also known as an input circuit) and a controlled system (also known as an output circuit), and is typically used in automatic control circuits. Essentially, the relay is an “automatic switch” that uses a smaller current to control a larger current. Therefore, it plays roles such as automatic regulation, safety protection, and circuit switching in electrical circuits.

Auxiliary contacts are usually provided in the existing relay, and the open/closed state between the movable contact and the static contact is monitored through the contact or separation of the auxiliary movable contact and the auxiliary static contact in the auxiliary contact. However, there are several factors in the relay that affect the working state of the auxiliary movable contact. First, an arc generated when the main contact is separated may pollute the auxiliary movable contact and affect the normal work of the auxiliary movable contact. Second, when the creepage distance between the auxiliary movable contact and the main movable contact part is too short, the working performance of the auxiliary movable contact will be affected. It is worth noting that when the auxiliary movable contact fails to work normally, it will affect the monitoring state of the auxiliary movable contact on the main contact, and then it will affect the safety performance and structural performance of the relay.

### SUMMARY

A push rod assembly of the disclosure, includes a push rod, an auxiliary movable contact part and an isolation cover, the auxiliary movable contact part includes an auxiliary movable contact piece and an auxiliary movable contact, an end portion of the auxiliary movable contact piece being provided with the auxiliary movable contact; the isolation cover being connected to the push rod and the auxiliary movable contact piece, so that the isolation cover and the auxiliary movable contact part follow the push rod; the isolation cover covers the auxiliary movable contact to isolate the auxiliary movable contact from a main movable contact part; and the isolation cover is configured to extend an creepage distance from the main movable contact part to the auxiliary movable contact part.

According to some embodiments of the disclosure, a part of the auxiliary movable contact piece is wrapped inside a part of the isolation cover, a rest part of the auxiliary movable contact piece extends from the part of the isolation cover; another part of the isolation cover covers the rest part of the auxiliary movable contact piece auxiliary movable contact piece extending from the isolation cover and the auxiliary movable contact.

According to some embodiments of the disclosure, the isolation cover includes a main body and a cover case, wherein:
the main body is connected to the push rod and the auxiliary movable contact piece;
the cover case is connected to the main body, and the cover case covers the rest part of the auxiliary movable contact piece extending from the main body and the auxiliary movable contact.

According to some embodiments of the disclosure, along a length direction of the auxiliary movable contact piece, both ends of the auxiliary movable contact piece are provided with the auxiliary movable contacts; a number of the cover case is two, and the two cover cases are placed on an opposite side of the main body along the length direction of the auxiliary movable contact piece, and each cover case cover the auxiliary movable contacts at a same end of the auxiliary movable contact piece.

According to some embodiments of the disclosure, along the length direction of the auxiliary movable contact piece, a middle area of the auxiliary movable contact piece is provide with a first through hole, the main body wraps the middle area, and axial end of the push rod passes through the first through hole, and the axial end of the push rod is integrally formed in the main body.

According to some embodiments of the disclosure, in the direction perpendicular to the axial direction of the push rod, the cover cases are provided with openings.

According to some embodiments of the disclosure, along an arrangement direction of two cover cases, each cover case is provided with one opening on a side facing away from another cover case.

According to some embodiments of the disclosure, the cover case including:
two first plate bodies, the two first plate bodies are oppositely arranged, and an arrangement direction of the two first plate bodies is perpendicular to the axial direction of the push body and the length direction of the auxiliary movable contact piece;
a second plate body, along the length direction of the auxiliary movable contact piece, the second plate body connects to ends of the two first plate bodies facing the main body;
a top plate, the top plate connects to the two first plate bodies and the second plate body, to form a chamber for accommodating the auxiliary movable contact; the top plate and two first plate bodies form openings on sides facing away from the main body.

According to some embodiments of the disclosure, the openings on the two cover cases are arranged along a diagonal of the isolation cover, and the main body cooperates with each house to form an opening.

According to some embodiments of the disclosure, the cover case including a first plate body and a second plate body, wherein:
the first plate body connects to the main body, and an extending direction of the first plate body is perpendicular to an axial line of the push rod;
the second plate body extends from the first plate body, and an extending direction of the second plate body is perpendicular to an extending direction of the first plate body, the second plate body is provided with the openings.

According to some embodiments of the disclosure, the push rod assembly further includes a contact bracket, the contact bracket connects to the isolation cover, and the contact bracket follows the push rod.

According to some embodiments of the disclosure, the contact bracket is connected to the push rod, the auxiliary movable contact part and the isolation cover by integral injection molding.

According to some embodiments of the disclosure, the contact bracket includes a bottom plate, an upper plate and two side plates arranged oppositely, along the axial direction of the push rod, two side plates are located on a same side of the bottom plate, and the upper plate is connected to another end of the two side plates facing away from the bottom plate.

According to some embodiments of the disclosure, the isolation cover further includes two extending structures, along an arrangement direction of the two side plates, two extending structures extend from the opposite sides of the main body; each extending structure extends away from the push rod, and each extending structure wraps one end of the side plate near the main body.

According to some embodiments of the disclosure, a connecting structure is provided between the cover case and the extending structure adjacent to the cover case, the connecting structure connects to the cover case and the main body and/or the extending structure, to block the gap between the cover case and the main body and/or the extending structure.

According to some embodiments of the disclosure, along an axial direction of the push rod, a spring member is installed at a side of the isolation cover facing away from the push rod.

According to some embodiments of the disclosure, along the axial direction of the push rod, an isolation blocking wall is provided at a side of the main body facing away from the push rod, the isolation blocking wall extends from a surface of the main body facing away from the push rod; and along a radial direction of the push rod, the isolation blocking wall is arranged at at least one side of the spring member.

According to some embodiments of the disclosure, the isolation cover connects to the push rod and the auxiliary movable contact part by integral injection molding.

A relay includes a push rod assembly according to some embodiments of the disclosure.

According to some embodiments of the disclosure, further includes a yoke plate and an auxiliary lead-out piece, the auxiliary lead-out piece and the push rod of the push rod assembly runs through the yoke plate, the auxiliary lead-out piece is provided with an auxiliary static contact corresponding to the auxiliary movable contact at a side of the yoke plate facing the auxiliary movable contact part.

A method for manufacturing push rod assembly, including:
by adopting an injection molding process, a push rod and an auxiliary movable contact part are connected to form an isolation cover, and the isolation cover covers an auxiliary movable contact of the auxiliary movable contact part.

A method for manufacturing push rod assembly, including:
by adopting an injection molding process, forming a first structural member at preset positions of a push rod and an auxiliary movable contact part, and the push rod and the auxiliary movable contact part are connected through the first structural member; and
by adopting an injection molding process again, making a second structural member on a surface of the first structural member to form an isolation cover; wherein, the isolation cover covers an auxiliary movable contact of the auxiliary movable contact part to isolate the auxiliary movable contact from a main movable contact part; and the isolation cover is configured to extend a creepage distance from the main movable contact part to the auxiliary movable contact part.

According to some embodiments of the disclosure, the method for molding process forming a first structural member at preset positions of a push rod and an auxiliary movable contact part by adopting an injection, further including:
providing a contact bracket; and
forming the first structural member at preset positions of an axial end of the push rod, the auxiliary movable contact part and the contact bracket by adopting an injection molding process.

### BRIEF DESCRIPTION OF THE DRAWINGS

FIG. 1 shows a top view of the relay provided by an embodiment of the present disclosure.

FIG. 2 is a sectional view taken along line A-A in FIG. 1.

FIG. 3 is a schematic diagram showing the three-dimensional structure of the push rod assembly in FIG. 2 after being assembled with the main movable contact part.

FIG. 4 is a schematic plan view of the structure in FIG. 3.

FIG. 5 is a sectional view taken along line B-B in FIG. 4.

FIG. 6 is a schematic plan view of the structure in FIG. 3 at another angle.

FIG. 7 is a sectional view taken along line C-C in FIG. 6.

FIG. 8 is a schematic diagram showing the three-dimensional structure of the push rod assembly in FIG. 2.

FIG. 9 is a schematic view of the push rod assembly in FIG. 8 from another angle.

FIG. 10 is a schematic diagram showing current creep on the surface of the push rod assembly in FIG. 8.

FIG. 11 is a schematic diagram showing the structural division of the push rod assembly in FIG. 10.

FIG. 12 is an exploded schematic view of a part of the structure of the push rod assembly in FIG. 11.

FIG. 13 is a structural schematic diagram showing the structure of the rest part of the push rod assembly in FIG. 11.

FIG. 14 is a schematic view of the structure in FIG. 13 from another angle.

FIG. 15 is a schematic diagram of the second three-dimensional structure of the push rod assembly provided by the embodiment of the present disclosure after being assembled with the main movable contact part.

FIG. 16 is a schematic diagram of the second three-dimensional structure of the push rod assembly provided by the embodiment of the present disclosure.

FIG. 17 is a schematic diagram showing the three-dimensional structure of the push rod assembly in FIG. 16.

FIG. 18 is a structural schematic diagram showing the structure of the rest part of the push rod assembly in FIG. 11.

FIG. 19 is a schematic view of the structure in FIG. 18 from another angle.

FIG. 20 is an enlarged sectional view of the auxiliary lead-out pieces in FIG. 2.

FIG. 21 is a structural diagram of the auxiliary lead-out pieces in FIG. 20.

FIG. 22 shows a second structural diagram of the auxiliary lead-out pieces in FIG. 21.

FIG. 23 is a flowchart of the manufacturing method of the push rod assembly provided by the embodiment of the present disclosure.

Reference numerals are explained as follows:
10, relay; 100, yoke plate; 200, insulating cover; 300, main contact part; 310, main movable contact part; 311, movable contact; 320, fixed contact; 321, lead-out terminal; 322, static contact; 400, push rod assembly; 410, push rod; 420, auxiliary movable contact part; 421, auxiliary movable contact piece; 4211, first through hole; 422, auxiliary movable contact; 430, isolation cover; 431, main body; 431a, first structural member; 431b, second structural member; 4311, isolation blocking wall; 4312, extending structure; 4313, limiting structure; 432, cover case; 4321, opening; 4322, first plate body; 4323, second plate body; 4324, top plate; 4325, auxiliary opening; 433, connecting structure; 440, spring member; 450, contact bracket; 451, side plate; 452, bottom plate; 453, upper plate; 500, magnetic circuit assembly; 600, auxiliary lead-out piece; 700, connecting assembly; 710, ceramic member; 720, transition piece.

### DETAILED DESCRIPTION

Example embodiments will now be described more fully with reference to the accompanying drawings. Example embodiments may, however, be embodied in various forms and should not be construed as limited to the embodiments set forth herein; rather, these embodiments are provided so that this disclosure will be thorough and complete, and will fully convey the concepts of the examples.

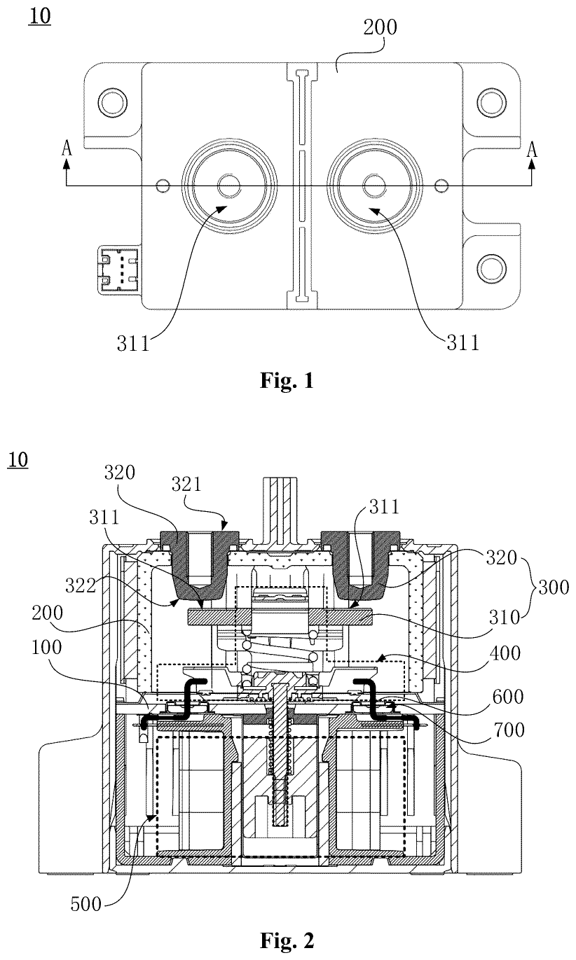

As shown in FIG. 1 to FIG. 2, an embodiment of the present disclosure provides a relay 10, the relay 10 includes a yoke plate 100, an insulating cover 200, a main contact part 300, a push rod assembly 400 and a magnetic circuit assembly 500.

It is understood that the terms “include” and “have” and any of their variations used in the embodiments of the present disclosure are intended to cover non-exclusive inclusions. For example, a process, method, system, product, or apparatus that includes a series of steps or units is not limited to the listed steps or units, but may optionally include steps or units not listed, or may optionally include other inherent steps or components for these processes, methods, products, or apparatuses.

The yoke plate 100 is provided with a through hole structure, through hole structure runs through two sides of the yoke plate 100 in the thickness direction, the insulating cover 200 is disposed on one side surface of the yoke plate 100, and covers the through hole structure of the yoke plate 100.

The main contact part 300 includes a main movable contact part 310 and two fixed contacts 320. The fixed contact 320 is fixed relative to the insulating cover 200, and one end of the fixed contact 320 penetrates to the outside of the insulating cover 200 to form a lead-out terminal 321. The other end of the fixed contact 320 located in the insulating cover 200 forms a static contact 322. It should be understood that the static contact 322 and the fixed contact 320 can be separated or integrated, that is, the static contact 322 can be separately installed on the surface of the fixed contact 320, or the static contact 322 can be formed by part of the fixed contact 320. The main movable contact part 310 is movably arranged in the insulating cover 200. The main movable contact part 310 includes a main movable contact piece, and the movable contact 311 is arranged at both ends of the main movable contact piece in the length direction. Similarly, the movable contact 311 and the main movable contact piece can be separated or integrated, that is, the movable contact 311 can be separately installed on the surface of the main movable contact piece, or, the movable contact 311 can be formed by part of the main movable contact piece. Each movable contact 311 corresponds to one static contact 322, and the movable contact 311 follows the main movable contact part 310 to contact with or break away from its corresponding static contact 322, so as to realize connection or disconnection of the main contacts of the main contact part 300.

It should be understood that the movable contact 311 and the static contact 322 in the main contact part 300 form main contacts.

The push rod assembly 400 runs through the yoke plate 100. Specifically, the push rod assembly 400 is movably installed in the through hole structure of the yoke plate 100. the main movable contact part 310 of the main contact part 300 follows the push rod assembly 400. When the push rod assembly 400 moves back and forth, it can drive the main movable contact part 310 to move, and then the main contacts of the main contact part 300 can be connected or disconnected.

The magnetic circuit assembly 500 is used to drive the push rod assembly 400 to move back and forth, so that the main movable contact part 310 follows the push rod assembly 400, and then the main contacts of the main contact part 300 are connected or disconnected. In FIG. 2, the magnetic circuit assembly 500 is roughly circled by a dotted box, and the specific position may be deviated.

The push rod assembly 400 in the relay 10 provided by the embodiment of the present disclosure can be the push rod assembly 400 in any of the following technical schemes. Of course, the push rod assembly 400 can also be disposed according to the requirements, which will not be described here.

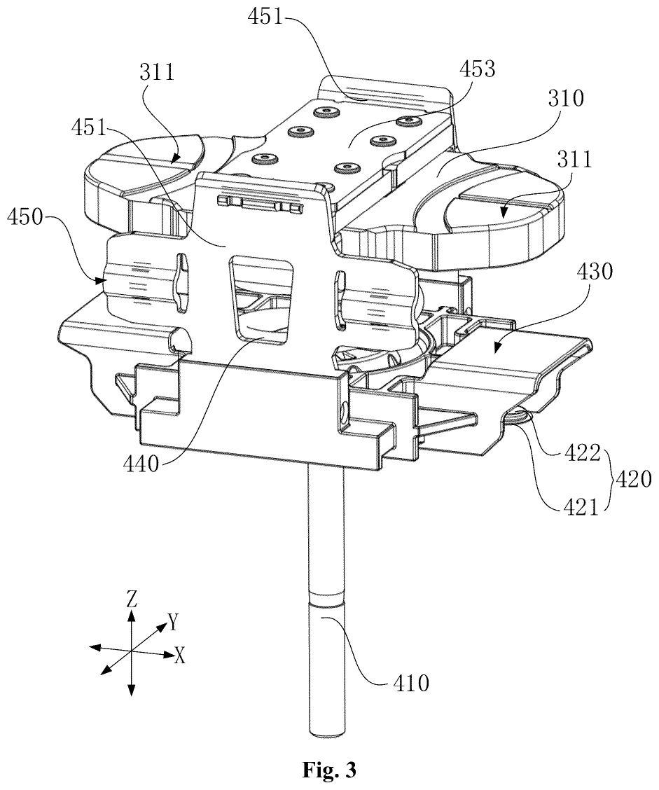

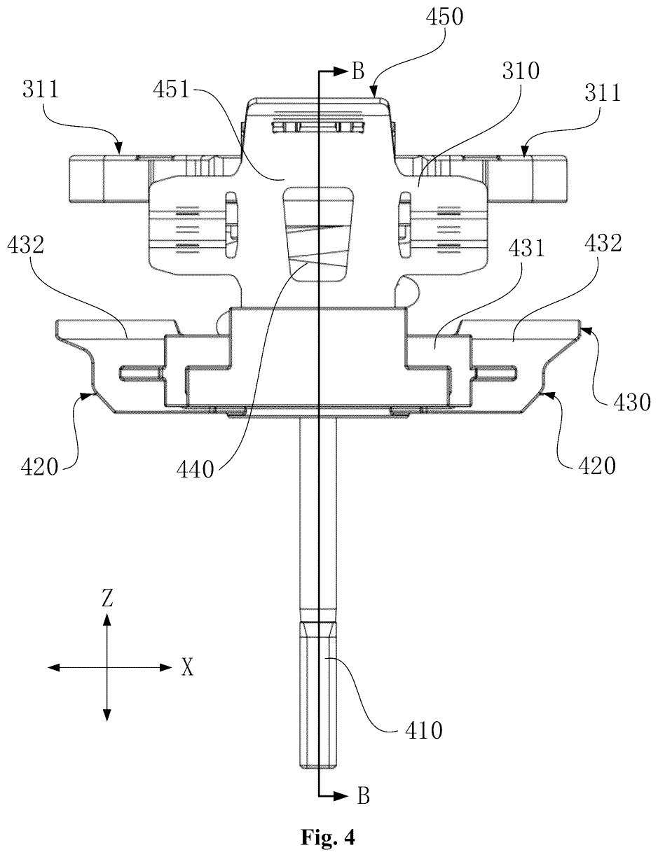

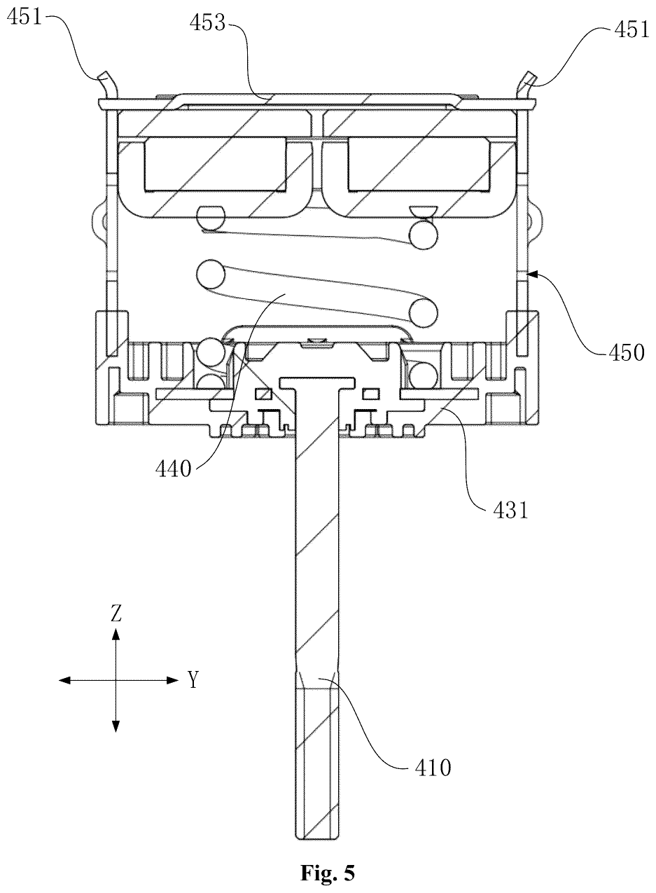

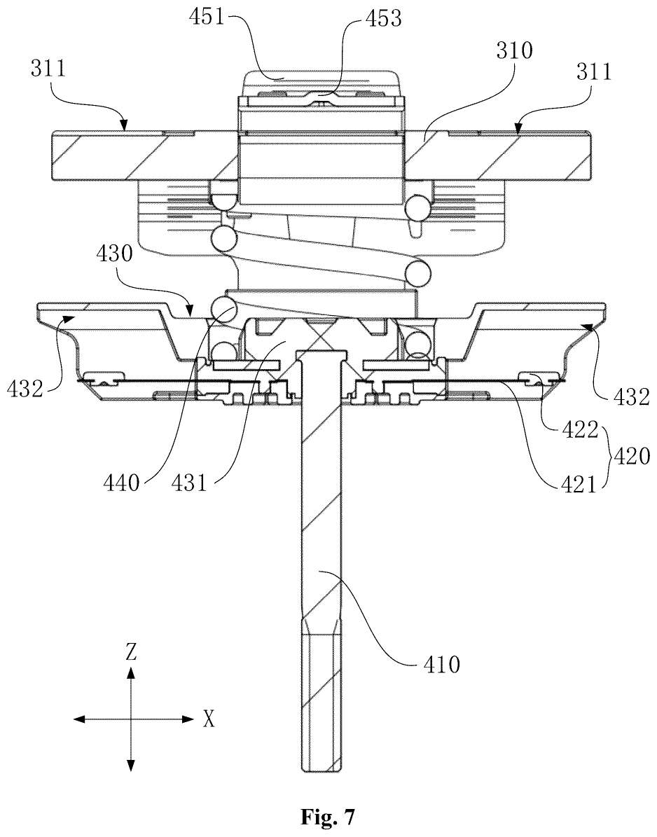

Please refer to the structures shown in FIGS. 3 to 19 with reference to FIGS. 1 and 2. An embodiment of the present disclosure provides a push rod assembly 400. As shown in FIGS. 3 to 9, the push rod assembly 400 includes a push rod 410, an auxiliary movable contact part 420 and an isolation cover 430. The auxiliary movable contact part 420 includes an auxiliary movable contact piece 421 and an auxiliary movable contact 422, and the end of the auxiliary movable contact piece 421 is provided with the auxiliary movable contact 422; The isolation cover 430 connects the push rod 410 and the auxiliary movable contact piece 421, so that the isolation cover 430 and the auxiliary movable contact part 420 follow the push rod 410; The isolation cover 430 covers the auxiliary movable contact 422 to isolate the auxiliary movable contact 422 from the main movable contact part 310; The isolation cover 430 is used to extend the creepage distance from the main movable contact part 310 to the auxiliary movable contact part 420.

It should be noted that in the push rod assembly 400 provided by the embodiment of the present disclosure, the isolation cover 430 covers the auxiliary movable contact 422, To separate the auxiliary movable contact 422 from the main movable contact part 310, Such that the movable contact 311 on the main movable contact part 310 and the auxiliary movable contact 422 in the auxiliary movable contact part 420 are separated on both sides of the isolation cover 430 along the axial direction of the push rod 410. Accordingly, when the movable contact 311 is separated from the static contact 322 to generate an arc, the isolation cover 430 can form isolation protection for the auxiliary movable contact 422 to prevent the auxiliary movable contact 422 from being polluted by the arc.

Meanwhile, in the push rod assembly 400 provided by the embodiment of the present disclosure, the isolation cover 430 can increase the creepage distance between the auxiliary movable contact piece 421 and the main movable contact part 310, which can be applied to the environment with higher voltage, so as to expand the application scenarios of the push rod assembly 400 and improve the insulation grade and structural performance of the relay 10 to which the push rod assembly 400 is applied.

In addition, in the push rod assembly 400 provided by the embodiment of the present disclosure, the isolation cover 430 is connected with the auxiliary movable contact part 420 and the push rod 410, So that the isolation cover 430 and the auxiliary movable contact part 420 follow the push rod 410, the overall dimension chain is small, and the control accuracy is high, which ensures the consistency of the motion trajectories of the movable contact 311 and the auxiliary movable contact 422. Moreover, the isolation cover 430 follows the auxiliary movable contact piece 421, so there is no need to reserve the movable space of the auxiliary movable contact part 420, and the structure is compact. In addition, the number of parts is simplified, the cost is reduced, the assembly process is reduced, and the risk of non-conduction caused by scraping is avoided.

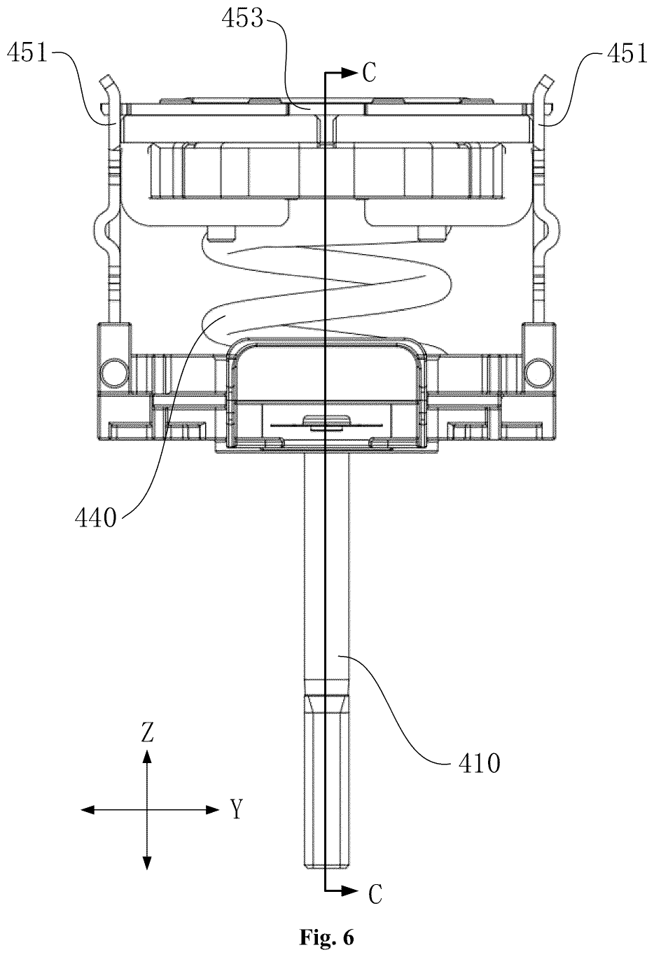

In one embodiment, as shown in FIGS. 6 to 9, a part of the auxiliary movable contact piece 421 is wrapped inside a part of the isolation cover 430, and a remaining part of the auxiliary movable contact piece 421 extends from the part of the isolation cover 430; Another part of the isolation cover 430 covers the remaining part of the auxiliary movable contact piece 421 extending from the isolation cover 430 and the auxiliary movable contact 422. In other words, along the axial direction of the push rod 410, the isolation cover 430 has a closed structure on the side of the auxiliary movable contact piece 421 facing away from the push rod, and the surface of the isolation cover 430 has no holes to provide a creepage path.

In the push rod assembly 400 provided by the embodiment of the present disclosure, the isolation cover 430 can effectively extend the creepage distance between the auxiliary movable contact piece 421 and the main movable contact part 310, so as to improve the insulation grade and structural performance of the relay 10 using the push rod assembly 400. Furthermore, the push rod assembly 400 can be applied to a larger voltage environment to expand application scenarios.

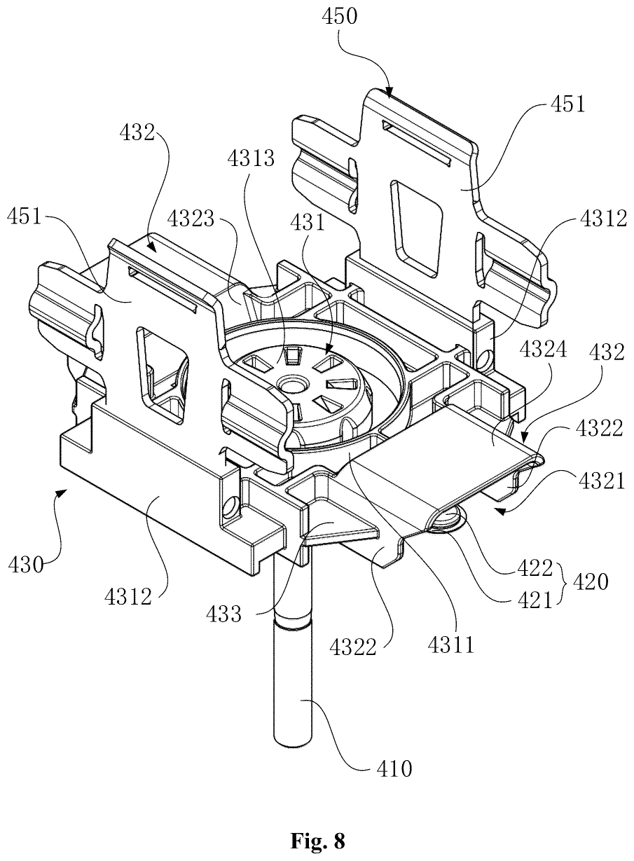

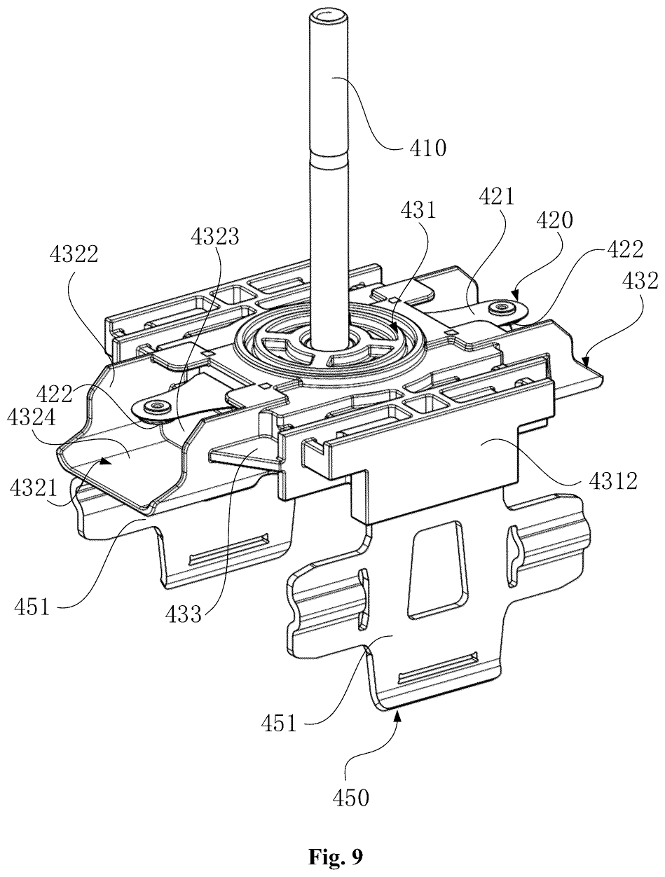

In a specific embodiment, as shown in FIGS. 8 and 9, the isolation cover 430 includes a main body 431 and a cover case 432. Wherein the main body 431 connects to the push rod 410 and the auxiliary movable contact piece 421; the cover case 432 connects to the main body 431 and covers the remaining part of the auxiliary movable contact piece 421 extending from the main body 431 and the auxiliary movable contact 422.

It should be noted that in this embodiment, the cover case 432 isolates the auxiliary movable contact 422 from the movable contact 311. When the movable contact 311 is separated from the static contact 322 to generate an arc, the cover case 432 can form isolation protection for the auxiliary movable contact 422 to prevent the auxiliary movable contact 422 from being polluted by the arc. Meanwhile, the cover case 432 can extend the creepage distance from the main movable contact part 310 to the auxiliary movable contact part 420.

In one embodiment, as shown in FIGS. 3 to 7, along the axial direction of the push rod 410, the spring member 440 is installed on the side of the isolation cover 430 facing away from the push rod 410. The spring member 440 abuts against the main movable contact part 310, so that the spring member 440 is charged by the main movable contact part 310. Accordingly, in this embodiment, the creepage distance from the main movable contact part 310 to the auxiliary movable contact piece 421 can be understood as the creepage distance from the spring member 440 to the auxiliary movable contact piece 421. It should be understood that the spring member 440 in the embodiment of the present disclosure can be a contact spring or a leaf spring, and by way of example, the spring member 440 is shown as a contact spring in various drawings.

It can be understood that the lead-out terminal 321 of the fixed contact 320 is used to connect with a load, so the current flowing after the main movable contact part 310 contacts with two static contact 322 is strong current. Because the spring member 440 is in contact with the main movable contact part 310, the spring member 440 also circulates strong electricity. On the contrary, the auxiliary movable contact part 420 and the auxiliary lead-out piece 600 (as shown in FIG. 2) circulate weak current. The isolation cover 430 can also separate the spring member 440 from the auxiliary movable contact 422 to isolate the strong and weak current.

As shown in FIGS. 3 to 7, along the axial direction of the push rod 410, the spring member 440 and the auxiliary movable contact part 420 are isolated on both sides of the isolation cover 430. The creepage path from the spring member 440 to the auxiliary movable contact part 420 includes the part from the main body 431 to the edge of the cover case 432 far from the main body 431, and, after crossing the edge of the cover case 432, the part from the edge of the cover case 432 to the auxiliary movable contact part 420. In this embodiment, there is no hole structure on the surface of the isolation cover 430 to provide a creepage path.

Accordingly, the isolation cover 430 in the embodiment of the present disclosure can extend the creepage distance from the spring member 440 to the auxiliary movable contact part 420, so as to improve the insulation grade of the relay 10 and improve the structural performance and safety performance of the relay 10.

In addition, in the push rod assembly 400 provided by this embodiment, the isolation cover 430 and the auxiliary movable contact part 420 follow the push rod 410. In this way, the isolation cover 430 does not need to reserve an activity space for the auxiliary movable contact part 420, which makes the relay 10 more compact in structure and smaller in volume.

As an example, the isolation cover 430 is connected to the push rod 410 and an auxiliary movable contact part 420 by integral injection molding. In other words, the isolation cover 430, the push rod 410 and the auxiliary movable contact part 420 form a whole by injection molding. When the push rod 410 moves, the isolation cover 430 and the auxiliary movable contact part 420 can move together with the push rod 410.

In the push rod assembly 400 provided by the embodiment of the disclosure, the isolation cover 430, the auxiliary movable contact part 420 and the push rod 410 are designed as a whole. The number of dimension chains is small, and the control accuracy is high, which ensures the consistency of the motion trajectories of the movable contact 311 and the auxiliary movable contact 422.

Of course, in other embodiments, the isolation cover 430 and the auxiliary movable contact part 420, and the isolation cover 430 and a push rod 410 can also be connected by gluing, clamping, etc., which will not be described in detail.

It can be understood that the isolation cover 430 can be made of insulating plastics with high temperature resistance, such as PA6T and PA10T.

As shown in FIG. 9, along the length direction of the auxiliary movable contact piece 421, both ends of the auxiliary movable contact piece 421 are provided with the auxiliary movable contact 422. The number of the cover case 432 is two, and two cover case 432 are placed on the opposite sides of the main body 431 along the length direction of the auxiliary movable contact piece 421, and each cover case 432 covers the auxiliary movable contacts 422 at the same end of the auxiliary movable contact piece 421.

It should be noted that in this embodiment, each cover case 432 carries out effective isolation protection on the auxiliary movable contact 422 corresponding to the cover case 432, so as to avoid arc pollution to the auxiliary movable contact 422. In order to prolong the service life of the auxiliary movable contact 422 and further improve its detection accuracy and structural performance of the relay 10.

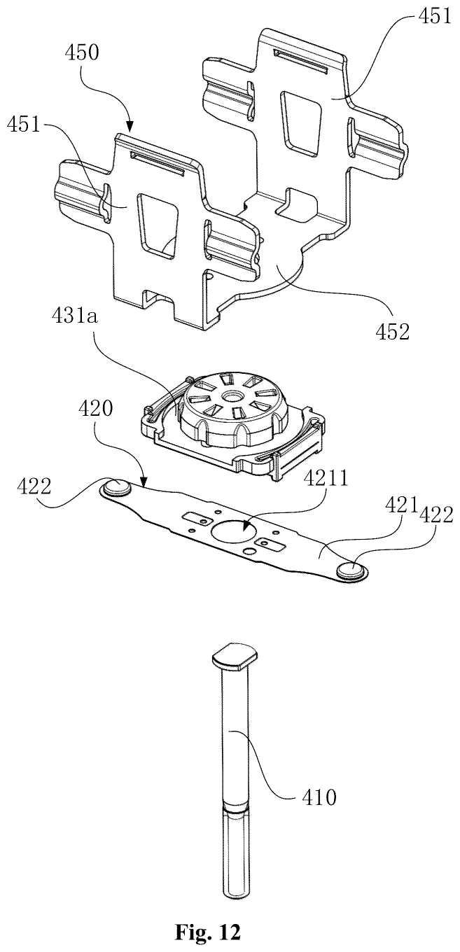

It is worth noting that in order to facilitate the integrated injection molding of the auxiliary movable contact piece 421 and the push rod 410, along the length direction of the auxiliary movable contact piece 421, a middle area of the auxiliary movable contact piece 421 is provided with the first through hole 4211 (as shown in FIG. 12), the main body 431 is wrapped around the middle area, and one axial end of the push rod 410 penetrates through the first through hole 4211. Accordingly, when the isolation cover 430 is formed by injection molding, one axial end of the push rod 410 can be integrally formed in the main body 431, so as to simplify the number of structural parts and reduce the preparation difficulty.

Please continue to refer to the structure shown in FIG. 9, the cover case 432 is open at the side facing away from the main movable contact part 310, which is convenient for assembly and injection molding.

In one embodiment, as shown in FIGS. 8 and 9, the cover case 432 is provided with the opening 4321 in the direction perpendicular to the axial direction of the push rod 410. It should be understood that the auxiliary static contact (described in the following structure) and the auxiliary movable contact 422 in the relay 10 provided by the embodiment of the present disclosure can be in a normally open state, and the opening 4321 does not affect the structural performance of the relay 10.

It should be noted that the structural design of the opening 4321 can play the role of weight reduction and assembly visualization, and further facilitate the demolding operation after injection molding, so as to reduce the preparation difficulty of the push rod assembly 400.

It is worth noting that the number of the opening 4321 on each cover case 432 can be one, two or three, etc., which can be disposed according to requirements.

There are many possibilities for the structure of the isolation cover 430 when disposing the isolation cover 430. Now, the structure of the isolation cover 430 is exemplified according to the disposing position of the opening 4321.

In one embodiment, as shown in FIGS. 8 and 9, along the arrangement direction of two cover cases 432, each cover case 432 is provided with an opening 4321 on the side facing away from the other cover case 432. It should be noted that this disposing can facilitate the demolding operation to reduce the difficulty of preparation and assembly.

In addition, it is worth noting that in this embodiment, two openings 4321 are located at the opposite sides of the cover case 432, which has a fool-proof function, and there is no need to worry about whether the cover cases 432 on both sides of the isolation cover 430 is reversed.

In this embodiment, as shown in FIGS. 8 and 9, the cover case 432 includes two first plate bodies 4322, a second plate body 4323 and a top plate 4324. The two first plate bodies 4322 are arranged oppositely, and the arrangement direction of the two first plate bodies 4322 is perpendicular to the axial direction of the push rod 410 and the length direction of the auxiliary movable contact piece 421. In other words, the arrangement direction of the two first plate bodies 4322 is parallel to the width direction of the auxiliary movable contact piece 421. In addition, two first plate bodies 4322 may be vertically arranged with the yoke plate 100. The second plate body 4323 connects one end of two first plate bodies 4322 facing the main body 431, and the second plate body 4323 connects the main body 431. The top plate 4324 connects two first plate bodies 4322 and the second plate body 4323 to form a chamber for accommodating the auxiliary movable contact 422; The top plate 4324 and two first plate bodies 4322 form the openings 4321 on the side facing away from the main body 431.

It should be noted that in this embodiment, two first plate bodies 4322, the second plate body 4323 and the top plate 4324 are equivalent to surrounding the auxiliary movable contact 422 from four directions. The isolation protection formed by the cover case 432 on the auxiliary movable contact 422 can be optimized, and the arc generated when the main contacts are separated can be prevented from polluting the auxiliary movable contact 422.

Meanwhile, in this embodiment, the second plate body 4323 or other plates are connected to the main body 431, so that the remaining part of the auxiliary movable contact piece 421 that passes through the main body 431 is covered by the isolation cover 430. There is no hole structure on the surface of the isolation cover 430 to provide a creepage path, so as to extend the creepage path or even the creepage distance from the spring member 440 to the auxiliary movable contact piece 421.

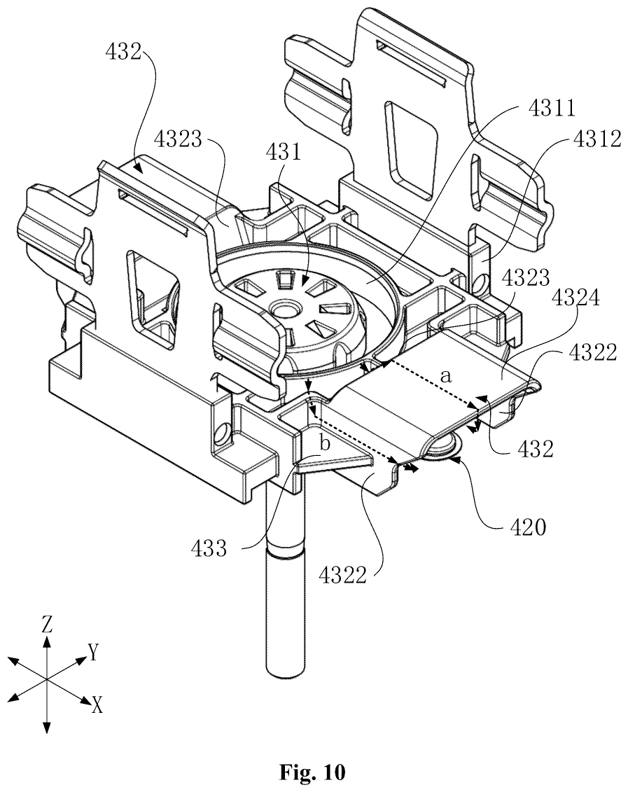

In order to clearly understand the creepage path from the spring member 440 to the auxiliary movable contact piece 421 in this embodiment, please refer to the structure shown in FIG. 10. Illustratively, in FIG. 10, the axial direction of the push rod assembly 400 is taken as the direction Z, the length direction of the auxiliary movable contact piece 421 is taken as the direction X, and the width direction of the auxiliary movable contact piece 421 is taken as the direction Y, wherein the directions X, Y and Z are perpendicular to each other.

In the process of current crawling from the spring member 440 to the auxiliary movable contact piece 421, the current crawls along the surface of the isolation cover 430, and there may be paths a and b. When the size of the first plate body 4322 in the direction X is larger than that of the top plate 4324 in the direction X, the current creeps along the path a on the surface of the top plate 4324; On the contrary, when the size of the first plate body 4322 in the direction X is smaller than that of the top plate 4324 in the direction X, the current creeps along the path b on the surface of the first plate body 4322.

Illustratively, as shown in FIG. 10, during the current crawling along the path a, the current crawls along the outer surface of the second plate body 4323 near the spring member 440 (shown in FIG. 3) to the top surface of the top plate 4324; Then, crawls on the top surface of the top plate 4324 along the direction X until reaching the edge of the top plate 4324 facing away from the main body 431, and the current is folded to the bottom surface of the top plate 4324; After that, the current moves reversely in the direction X along the bottom surface of the top plate 4324 until it reaches the auxiliary movable contact piece 421.

For example, as shown in FIG. 10, when the current crawls along the path b, the current crawls along the outer surface of the second plate body 4323 near the spring member 440 to the outer surface of the first plate body 4322. Then, as shown in FIG. 10, it crawls along the direction X on the outer surface of the first plate body 4322 until it reaches the edge of the first plate body 4322 facing away from the main body 431, and the current is folded to the inner surface of the first plate body 4322. After that, the current moves reversely in the direction X along the inner surface of the first plate body 4322 until it reaches the auxiliary movable contact piece 421.

As shown in FIGS. 3 to 10, the push rod assembly 400 further includes a contact bracket 450, which is connected to the isolation cover 430 and follows the push rod 410. The contact bracket 450 can be connected to the push rod 410, the auxiliary movable contact part 420 and the isolation cover 430 by integral injection molding, so as to further enhance the integration of the push rod assembly 400, further optimize the follow-up effect of each structural part and reduce the assembly difficulty.

As shown in FIG. 3 to FIG. 9 and FIG. 12, in a specific embodiment, the contact bracket 450 includes a bottom plate 452, an upper plate 453 and two opposite side plates 451. The two side plates 451 are located at the same side of the bottom plate 452, and the upper plate 453 is connected to the other ends of the two side plates 451 facing away from the bottom plate 452.

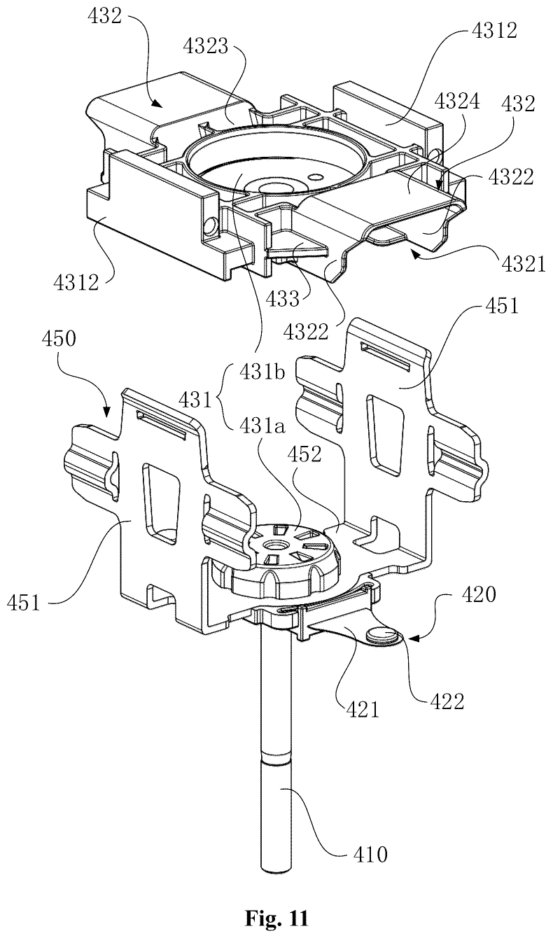

It should be understood that there are many possibilities for the structural type of the contact bracket 450. As an example, as shown in FIG. 11, in this embodiment, the bottom plate 452 and two side plates 451 are integrated, and the two side plates 451 cooperate with the bottom plate 452 to form a U-shaped structure, and the bottom plate 452 is wrapped inside the main body 431. It should be understood that the bottom plate 452 is provided with a through hole structure, so that the push rod 410 can be inserted into it.

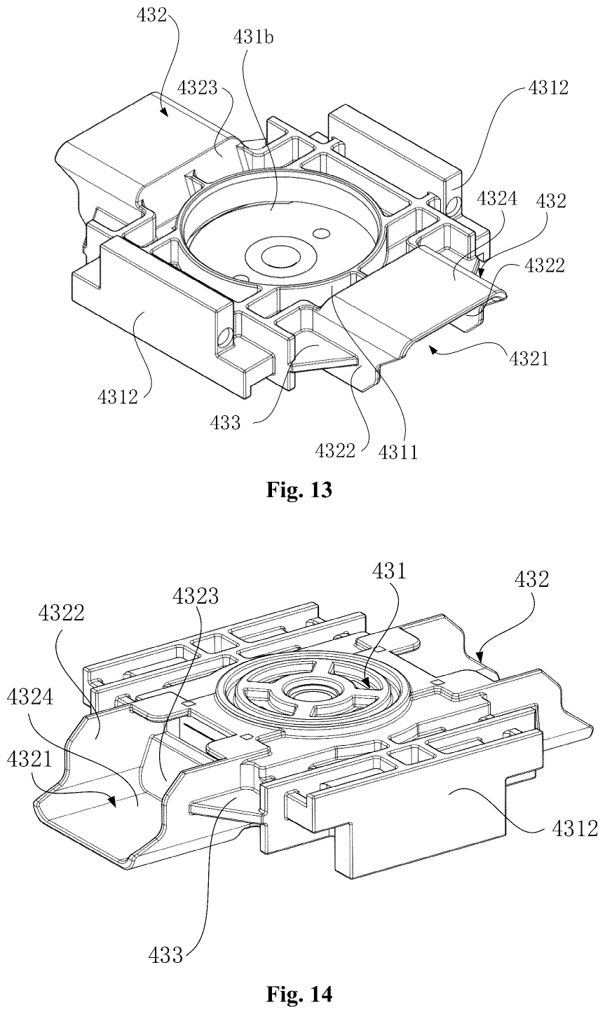

Please refer to FIG. 3 to FIG. 7 in conjunction with FIG. 13. After assembling relevant structural members in the U-shaped structure formed by the bottom plate 452 and the side plate 451, the upper plate 453 is installed on the side of the two side plates 451 facing away from the bottom plate 452. Notably, after the upper plate 453 is connected with the U-shaped structure, the spring member 440 can be elastically tensioned between the bottom surface of the main movable contact part 310 and the main body 431, and the main movable contact part 310 can be pushed to the inside of the upper plate 453.

When assembling the isolation cover 430 in the push rod assembly 400 provided by the embodiment of the present application, as shown in FIGS. 10 and 11, The main body 431 is divided into a first structural member 431a and a second structural member 431b, in which the first structural member 431a is formed in the first injection molding process and the second structural member 431b is formed in the second injection molding process. Illustratively, the form of the second structural member 431b is shown in FIGS. 13 and 14.

It is worth noting that after the first injection molding process, the push rod 410, the auxiliary movable contact part 420 and the first structural member 431a form an integral structure. Then, the second structural member 431b is prepared on the surface of the whole structure. The second structural member 431b covers at least part of the first structural member 431a to form a complete main body 431, and the cover case 432 is formed simultaneously.

In one embodiment, as shown in FIG. 8, the isolation cover 430 further includes two extending structures 4312 extending from opposite sides of the main body 431 along the arrangement direction of the two side plate 451; Each extending structure 4312 extends away from the push rod 410, and each extending structure 4312 wraps one end of the side plate 451 near the main body 431.

It should be understood that the shape of the extending structure 4312 can adapt to the flat state of the side plate 451, so as to improve the structural stability of the side plate 451 and the isolation cover 430 after injection molding.

As shown in FIGS. 8 to 9, the connecting structure 433 is arranged between the cover case 432 and the adjacent extending structure 4312. The connecting structure 433 connects to the cover case 432 and the main body 431 and/or the extending structure 4312, used to block the gap between the cover case 432 and the main body 431 and/or the extending structure 4312. Exemplary, the connecting structure 433 connects to the main body 431, the first plate body 4322 and the extending structure 4312.

It should be noted that, on the one hand, the connecting structure 433 can enhance the structural stability of the cover case 432 relative to the main body 431. On the other hand, the connecting structure 433 can avoid the gap between the outer wall of the cover case 432 and the extending structure 4312 to ensure that the creepage path is effectively extended. For example, if the current crawls from the main body 431 to the cover case 432 and the extending structure 4312 therebetween, the current needs to crawl along the connecting structure 433 until it reaches the first plate body 4322.

As shown in FIG. 8 and FIG. 10, along the axial direction of the push rod 410, the main body 431 is provided with an isolation blocking wall 4311 on the side facing away from the push rod 410, and the isolation blocking wall 4311 extends from the surface of the main body 431 towards the push rod 410. Along the radial direction of the push rod 410, the isolation blocking wall 4311 is arranged at at least one side of the spring member 440 in FIG. 3. The isolation blocking wall 4311 can be arranged in the current crawling path from the spring member 440 to the auxiliary movable contact part 420 to increase the creepage path from the spring member 440 to the auxiliary movable contact part 420, even the creepage distance.

It should be understood that “creepage path” refers to the possible creepage trajectory of two metal pieces between insulating surfaces, and “creepage distance” refers to the minimum creepage trajectory between two conductive parts measured along insulating surfaces.

It is worth noting that in this embodiment, in the plane perpendicular to Z, the isolation blocking wall 4311 can be designed as a local structure or a continuous structure, that is, the isolation blocking wall 4311 can be designed around the spring member 440 to effectively isolate the spring member 440. It can be understood that the isolation blocking wall 4311 can also limit the spring member 440 in a plane perpendicular to the direction Z, so as to improve the stability after the spring member 440 is assembled with the isolation cover 430.

Of course, the limiting structure 4313 as shown in FIG. 10 can also be arranged on the main body 431 of the isolation cover 430 to further limit the stability of the spring member 440 after assembly. For example, when the spring member 440 is a contact spring, the limiting structure 4313 may be a protrusion to extend into the hollow structure of the contact spring to assist the structural stability of the limit contact spring.

In addition, in order to enhance the stability of the cover case 432 relative to the main body 431, in a specific embodiment, the second plate body 4323 and the isolation blocking wall 4311 can also be provided with reinforcing structures.

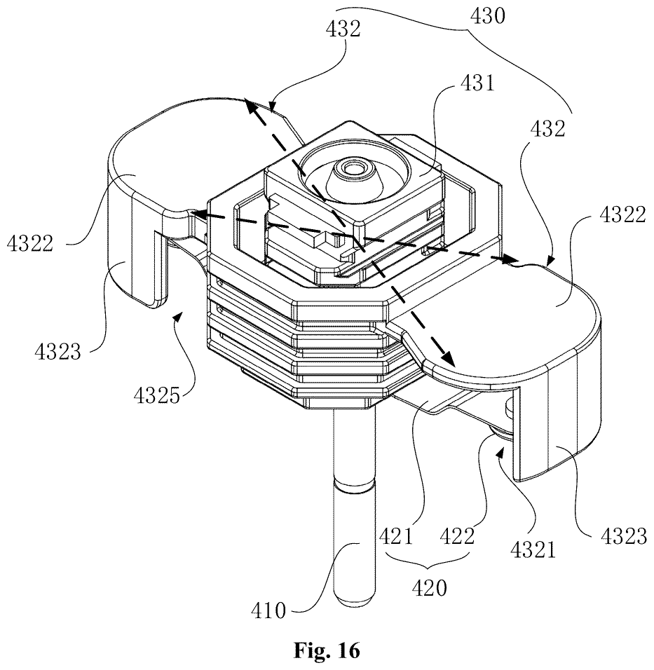

In another embodiment, as shown in FIGS. 16 to 19, the openings 4321 on two houses 432 are arranged along the diagonal of the isolation cover 430, and the main body 431 cooperates with each house 432 to form one opening 4321. The structure can facilitate the die demolding operation, so as to reduce the difficulty of preparation and assembly.

In the specific setting, the size of the opening 4321 in the direction perpendicular to the axial line of the push rod 410 can be disposed as required. For example, it can be disposed larger. It should be noted that when the size of the opening 4321 is disposed larger; the isolation cover 430 can realize the miniaturization design of the isolation cover 430 on the premise of meeting the safety requirements. Specifically, when assembling the isolation cover 430 provided by this embodiment, the auxiliary lead-out piece 600 can be put into the internal space of the isolation cover 430 from the opening 4321, and then, rotating the isolation cover 430 in the direction perpendicular to the axial line of the push rod 410, so that the isolation cover 430 is installed in place.

Of course, the size of the opening 4321 cannot be disposed too large so as to ensure the structural strength of the cover case 432 and make it meet the isolation requirements.

As shown in FIG. 16 to FIG. 19, in this embodiment, the number of the opening 4321 on the cover case 432 is two, and another opening 4321 is called the auxiliary opening 4325 here. Illustratively, the auxiliary opening 4325 is connected with the main body 431, and the auxiliary openings 4325 on two houses 432 are arranged along a second diagonal, and the second diagonal crosses the main body 431 and intersects with the first diagonal; In the plane perpendicular to the axial line of the push rod 410, the opening 4321 and the auxiliary opening 4325 on each cover case 432 are separated from each other, and the size of the auxiliary opening 4325 is smaller than that of the opening 4321. The structural design of the auxiliary opening 4325 can further facilitates the demolding operation, so as to reduce the difficulty of preparation and assembly.

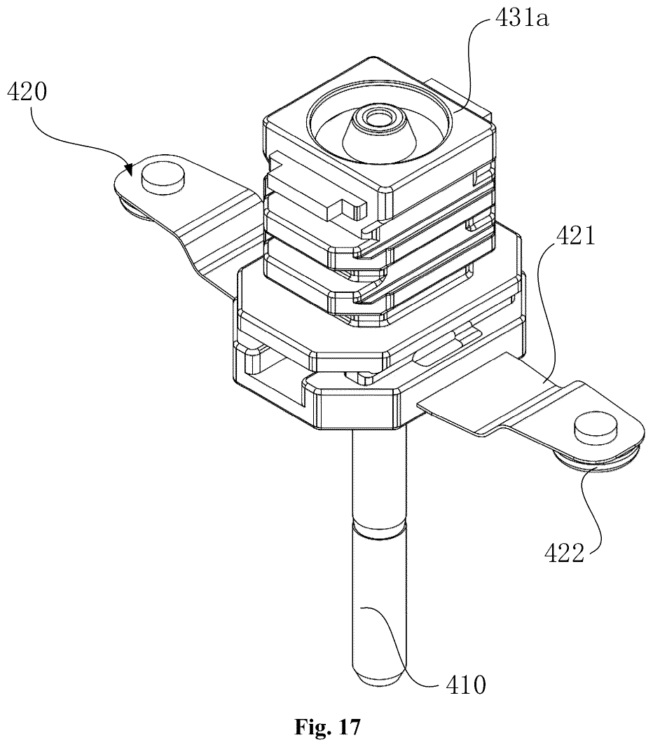

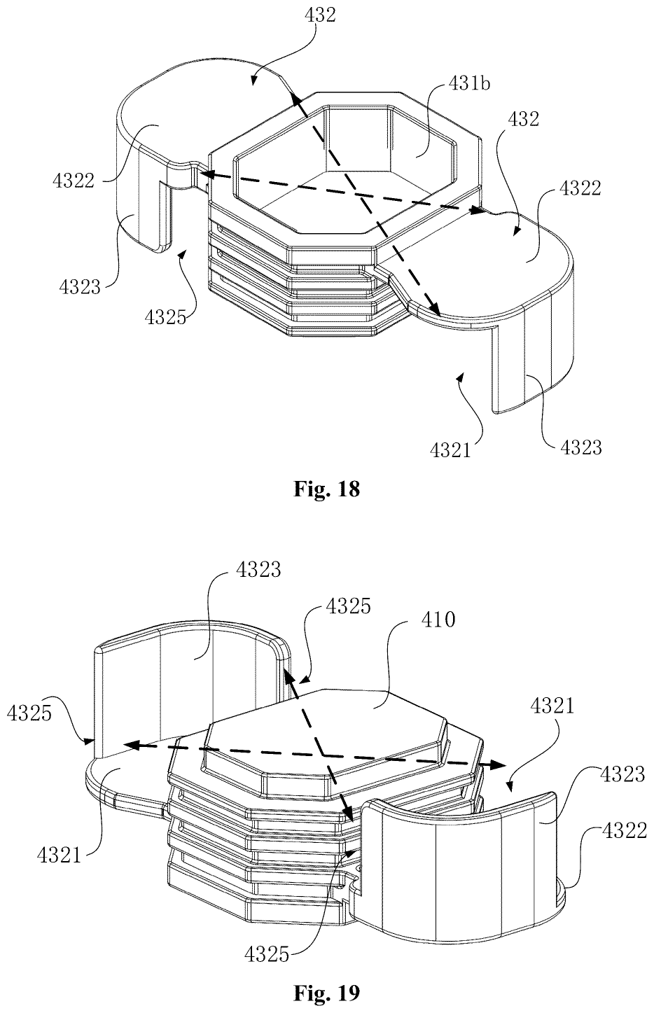

As shown in FIG. 16, in a specific embodiment, the cover case 432 includes a first plate body 4322 and a second plate body 4323. The first plate body 4322 is connected to the main body 431, and the extending direction of the first plate body 4322 is perpendicular to the axial line of the push rod 410; The second plate body 4323 extends from the first plate body 4322, and the extending direction of the second plate body 4323 is perpendicular to the extending direction of the first plate body 4322, and the opening 4321 is provided on the second plate body 4323. As shown in FIG. 18, there is a gap between the two ends of the second plate body 4323 and the main body 431, which forms the opening 4321 and the auxiliary opening 4325.

It is worth noting that because the cover case 432 needs to rotate in the assembly process, the extension state of the second plate body 4323 in the plane perpendicular to the axial line of the push rod 410 can be disposed to be arc, so as to save the space occupied by the cover case 432 and improve the structural performance of the relay 10.

When assembling each structural member in the push rod assembly 400 provided by the embodiment of the present application, as shown in FIGS. 17 to 19, There are two parts in the main body 431: a first structural member 431a (shown in FIG. 17) and a second structural member 431b (shown in FIGS. 18 and 19). Therein the first structural member 431a is formed in the first injection molding process, and the second structural member 431b is formed in the second injection molding process. Illustratively, the form of the second structural member 431b is shown in FIGS. 17 and 18.

It is worth noting that after the first injection molding process, the push rod 410, the auxiliary movable contact part 420 and the first structural member 431a form an integral structure. Then, the second structural member 431b is prepared on the surface of the whole structure. The second structural member 431b covers at least part of the first structural member 431a to form a complete main body 431, and the cover case 432 is formed simultaneously.

Of course, the push rod assembly 400 in this embodiment also includes a contact bracket 450, which is connected to the isolation cover 430 and follows the push rod 410. The contact bracket 450 can be connected to the push rod 410, the auxiliary movable contact part 420 and the isolation cover 430 by integral injection molding, so as to further enhance the integration of the push rod assembly 400, further optimize the follow-up effect of each structural part and reduce the assembly difficulty.

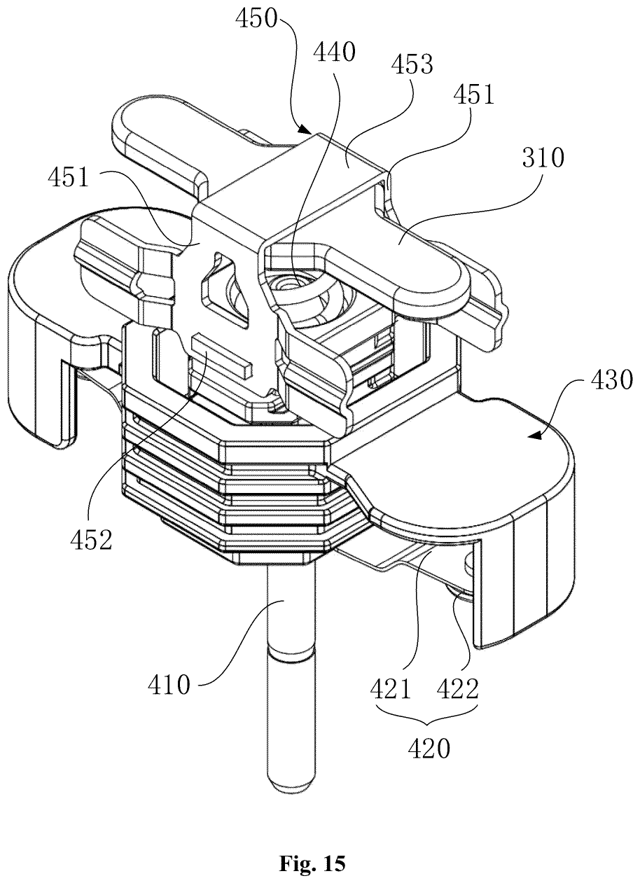

It is worth noting that, as shown in FIG. 15, the contact bracket 450 is also provided in the push rod assembly 400 in this embodiment. The contact bracket 450 may be the same as or different from the structural arrangement in FIGS. 11 and 12. In a specific example, as shown in FIG. 15, the side plate 451 and the upper plate 453 are integrated structures, and two side plates 451 and the upper plate 453 cooperate to form a U-shaped structure. The bottom plate 452 is partially wrapped in the main body 431, and both ends of the bottom plate 452 in the length direction extend out of the main body 431; The contact bracket 450 includes one upper plate 453 and two opposite side plates 451. The two side plates 451 cooperate with the upper plate 453 to form a U-shaped structure, and one side of each side plate 451 facing away from the upper plate 453 is fixed to the bottom plate 452. The arrangement direction of the two side plates 451 is perpendicular to the length direction of the auxiliary movable contact piece 421.

It is worth noting that, compared with the contact bracket 450 in another embodiment, the contact bracket 450 in this embodiment is inverted U-shaped, and the bottom plate 452 is fixed in the isolation cover 430 and connected with the contact bracket 450. Specifically, the bottom plate 452 extends out of each end of the main body 431 and is connected with the corresponding side plate 451 to improve the structural stability.

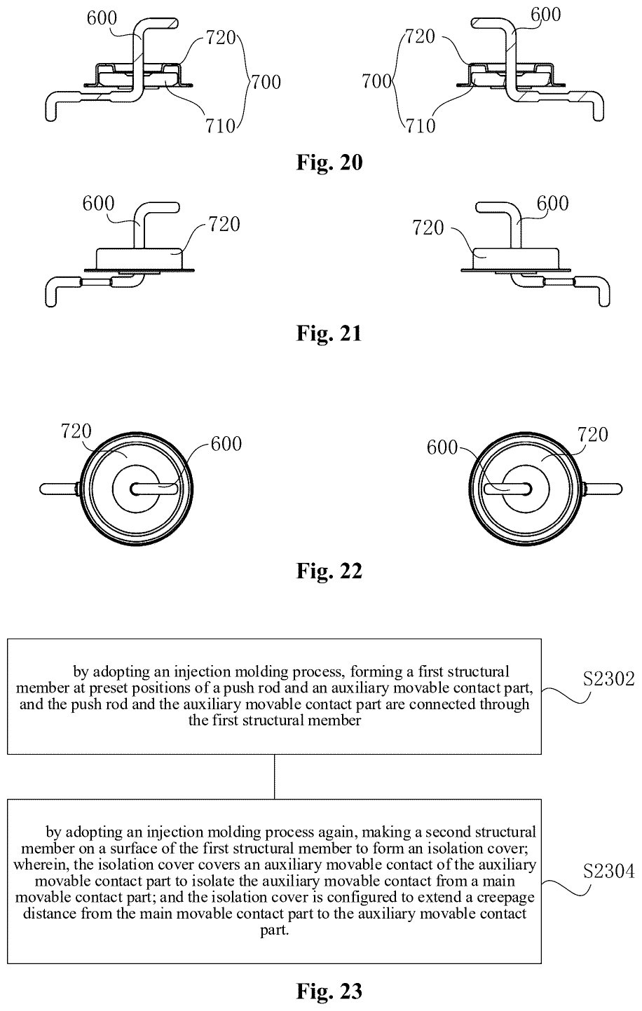

Please continue to refer to the structures shown in FIGS. 2 and 20. the relay 10 provided by the embodiment of the present disclosure further includes an auxiliary lead-out piece 600, and the push rod 410 and an auxiliary lead-out piece 600 run through the yoke plate 100. The auxiliary lead-out piece 600 is provided with an auxiliary static contact corresponding to the auxiliary movable contact 422 on the side of the yoke plate 100 facing the auxiliary movable contact part 420. The auxiliary lead-out piece 600 is used to contact with or separate from the auxiliary movable contact part 420 to monitor the connected/disconnected state between the movable contact 311 and the static contact 322.

In a specific embodiment, the auxiliary lead-out piece 600 and its corresponding auxiliary movable contact 422 can be in a normally open state.

Notably, as shown in FIG. 2, during the movement of the main movable contact part 310, the auxiliary movable contact part 420 moves with the main movable contact part 310; When the movable contact 311 on the main movable contact part 310 contacts the static contact 322, the auxiliary movable contact 422 on the auxiliary movable contact part 420 contacts the auxiliary static contact; On the contrary, when the movable contact 311 on the main movable contact part 310 is separated from the static contact 322, the auxiliary movable contact 422 on the auxiliary movable contact part 420 is separated from the auxiliary static contact.

Taking the contact and separation between the auxiliary movable contact 422 and the auxiliary static contact for further explanation, at the moment when both ends of the auxiliary movable contact part 420 move to combine with the auxiliary static contact, the auxiliary static contacts are connected in the detection loop, so that the main detection contacts (namely the movable contact 311 and the static contact 322) are connected; On the contrary, when the control coil of the relay 10 stops energizing, the movable iron core moves in the opposite direction of attraction under the elastic force of the reset spring, and at the same time, the auxiliary movable contact part 420 moves away from the auxiliary static contact with the reset of the movable iron core. At the moment when the two ends of the auxiliary movable contact part 420 are separated from the auxiliary static contact, the detection loop of the high-voltage DC relay 10 is disconnected, and the separation of the main contacts (namely, the movable contact 311 and the static contact 322) is detected.

The auxiliary lead-out piece 600 and the yoke plate 100 are connected by the connecting assembly 700 as shown in FIG. 2 and FIG. 20 to FIG. 22. For example, as shown in FIGS. 2 to 5, the yoke plate 100 is provided with a through hole structure, and the connecting assembly 700 is placed in the through hole structure to fix the auxiliary lead-out piece 600. Specifically, at the position where the auxiliary lead-out piece 600 passes through the yoke plate 100, the ceramic member 710 is fixed around the periphery of the auxiliary lead-out piece 600. The transition piece 720 covers the outside of the ceramic member 710, and the transition piece 720 forms a convex hull structure on the side facing away from the magnetic circuit assembly 500. The convex hull structure extends from the side edge of the ceramic member 710 near the magnetic circuit assembly 500 towards the direction away from the magnetic circuit assembly 500, and covers at least part of the surface of the ceramic member 710 facing away from the magnetic circuit assembly 500. As shown in FIG. 3 to FIG. 5, the convex hull structure is provided with a through hole at the penetrating position of the auxiliary lead-out piece 600, and the edge of the transition piece 720 forming the through hole is folded in the direction close to the ceramic member 710 and abuts against the ceramic member 710. The transition piece 720 can be made of metal.

A blade welding technology can be used when fixing the ceramic member 710 and the transition piece 720 to reduce welding stress and improve sealing performance. It should be understood that only a small flanging of the transition piece 720 contacts the ceramic member 710, so the welding area between the transition piece 720 and the ceramic member 710 can be reduced to reduce the welding stress and improve the sealing performance.

The embodiment of the disclosure also provides a manufacturing method for push rod assembly 400. The manufacturing method includes: connecting a push rod 410 and an auxiliary movable contact part 420 by an injection molding process to form an isolation cover 430, the isolation cover 430 covers the auxiliary movable contact 422 of the auxiliary movable contact part 420.

It should be noted that, in this embodiment, the push rod 410, the isolation cover 430 and the auxiliary movable contact part 420 are integrated through one-time manufacturing process. The manufacturing method is simple to operate, and can improve the operation efficiency and reduce the preparation cost.

Of course, the manufacturing method for the push rod assembly 400 can be used to manufacturing the push rod assembly 400 provided by any of the above technical solutions.

The embodiment of the disclosure also provides a manufacturing method for push rod assembly 400. Please refer to the structure shown in FIG. 23 with reference to FIGS. 1 to 22. The manufacturing method for push rod assembly 400 includes:

Step S2302: the first structural member 431a is formed at preset positions of a push rod 410 and an auxiliary movable contact part 420 by injection molding, as shown in FIG. 11. The push rod 410 and the auxiliary movable contact part 420 are connected through the first structural member 431a;

Step S2304: the second structural member 431b is formed on the surface of the first structural member 431a by injection molding again to form an isolation cover 430; As shown in FIG. 8 and FIG. 9, the isolation cover 430 covers the auxiliary movable contact 422 of the auxiliary movable contact part 420 to isolate the auxiliary movable contact 422 from the main movable contact part 310; the isolation cover 430 is used to extend the creepage distance from the main movable contact part 310 to the auxiliary movable contact part 420.

It should be noted that the manufacturing method for push rod assembly 400 provided by the embodiment of the application can reduce the manufacturing difficulty, improve the manufacturing efficiency, and improve the structural performance of the product.

When applying the manufacturing method for push rod assembly 400 provided by the embodiment of the present disclosure, it is not necessary to dispose positioning openings for the mold passing through on the isolation cover 430, and it is not necessary to use the mold core to position the auxiliary movable contact piece 421. The push rod assembly 400 manufactured by the manufacturing method provided by the embodiment of the disclosure can extend the creepage distance from the main movable contact part 310 to the auxiliary movable contact part 420, so as to improve the insulation grade of the relay 10 and improve the structural performance and safety performance of the relay 10. Moreover, the creepage distance between the auxiliary movable contact piece 421 and the main movable contact part 310 increases, the push rod assembly 400 can be applied in the environment with higher voltage to expand the application scenarios.

Furthermore, the push rod assembly 400 manufactured by the manufacturing method provided by the embodiment of the disclosure covers the auxiliary movable contact 422 through the isolation cover 430, separating the auxiliary movable contact 422 from the main movable contact part 310, such that the movable contact 311 on the main movable contact part 310 and the auxiliary movable contact 422 in the auxiliary movable contact part 420 are separated on both sides of the isolation cover 430 along the axial direction of the push rod 410. Accordingly, when the movable contact 311 is separated from the static contact 322 to generate an arc, the isolation cover 430 can form isolation protection for the auxiliary movable contact 422 to prevent the auxiliary movable contact 422 from being polluted by the arc.

In addition, in the manufacturing method provided by the embodiment of the present disclosure, the isolation cover 430 is connected with the auxiliary movable contact part 420 and the push rod 410, so that the isolation cover 430 and the auxiliary movable contact part 420 follow the push rod 410, the overall dimension chain is small, and the control accuracy is high, which ensures the consistency of the motion trajectories of the movable contact 311 and the auxiliary movable contact 422. Moreover, the isolation cover 430 follows the auxiliary movable contact piece 421, so there is no need to reserve the movable space for the auxiliary movable contact part 420, and the structure is compact. In addition, the number of parts is simplified, the cost is reduced, the assembly process is reduced, and the risk of non-conduction caused by scraping is avoided.

In one embodiment, step S2302 is executed, the manufacturing method that the first structural member 431a is formed at preset positions of a push rod 410 and an auxiliary movable contact part 420 by an injection molding process, further comprising:
providing the contact bracket 450;
forming the first structural member 431a at the axial end of the push rod 410 and preset positions of the auxiliary movable contact part 420 and the contact bracket 450 by injection molding.

It should be noted that the structural arrangement in this embodiment can further improve the integration of the push rod assembly 400, further optimize the follow-up effect of each structural member, reduce the assembly difficulty, and simplify the number of structural members.

Finally, it can be understood that the various examples/embodiments provided by the present disclosure can be combined with each other without contradiction, and detailed examples are not provided herein.

In the embodiments of the present disclosure, the terms “first”, “second”, “third” are used for descriptive purposes only and should not be understood as indicating or implying relative importance; the term “a plurality of” refers to two or more, unless there is a clear definition otherwise. The terms such as “installation”, “connected”, “connection”, “fixed” should be understood in a broad sense. For example, “connection” can be a fixed connection, or a removable connection, or an integral connection; “connected embodiment” can be directly connected, or indirectly connected through an intermediary medium. For the ordinary skilled person in the art, the specific meanings of these terms in the disclosure can be understood based on the specific circumstances.

In the description of the embodiments of the present disclosure, the terms “upper”, “lower”, “left”, “right”, “front”, and “rear” indicate a direction or position based on the orientation or position shown in the accompanying drawings. These terms are used only to facilitate the description of the embodiment and to simplify the description, and are not intended to indicate or imply that the device or unit referred to must have a specific direction, be constructed and operated in a specific orientation. Therefore, these terms should not be construed as limiting the embodiments of the disclosure.

In the description of this specification, terms such as “an embodiment,” “some embodiments,” “a specific embodiment” refer to the specific features, structures, materials, or characteristics described in conjunction with the embodiment or example being included in at least one embodiment or example of the disclosure. In this specification, the illustrative terms do not necessarily refer to the same embodiment or example. Moreover, the specific features, structures, materials, or characteristics described may be suitably combined in any one or more of the embodiments or examples.

The above description is merely a preferred embodiment of the present disclosure and is not intended to limit the embodiment. For the person skilled in the art, the present disclosure may be subject to various changes and modifications. Any modifications, equivalent substitutions, improvements, and the like made within the spirit and principles of the embodiments of the present disclosure should be included within the scope of protection of the embodiments of the present disclosure.

What is claimed is:

1. A push rod assembly, comprising:
a push rod;
an auxiliary movable contact part, the auxiliary movable contact part comprises an auxiliary movable contact piece and an auxiliary movable contact, an end portion of the auxiliary movable contact piece being provided with the auxiliary movable contact; and
an isolation cover, the isolation cover being connected to the push rod and the auxiliary movable contact piece, so that the isolation cover and the auxiliary movable contact part follow the push rod; the isolation cover covers the auxiliary movable contact to isolate the auxiliary movable contact from a main movable contact part; and the isolation cover is configured to extend an creepage distance from the main movable contact part to the auxiliary movable contact part.

2. The push rod assembly according to claim 1, wherein a part of the auxiliary movable contact piece is wrapped inside a part of the isolation cover, a rest part of the auxiliary movable contact piece extends from the part of the isolation cover; another part of the isolation cover covers the rest part of the auxiliary movable contact piece auxiliary movable contact piece extending from the isolation cover and the auxiliary movable contact.

3. The push rod assembly according to claim 2, wherein the isolation cover comprises a main body and a cover case, wherein:
the main body is connected to the push rod and the auxiliary movable contact piece;
the cover case is connected to the main body, and the cover case covers the rest part of the auxiliary movable contact piece extending from the main body and the auxiliary movable contact.

4. The push rod assembly according to claim 3, wherein along a length direction of the auxiliary movable contact piece, both ends of the auxiliary movable contact piece are provided with the auxiliary movable contacts; a number of the cover case is two, and the two cover cases are placed on an opposite side of the main body along the length direction of the auxiliary movable contact piece, and each cover case cover the auxiliary movable contacts at a same end of the auxiliary movable contact piece.

5. The push rod assembly according to claim 4, wherein along the length direction of the auxiliary movable contact piece, a middle area of the auxiliary movable contact piece is provide with a first through hole, the main body wraps the middle area, and axial end of the push rod passes through the first through hole, and the axial end of the push rod is integrally formed in the main body.

6. The push rod assembly according to claim 4, wherein in the direction perpendicular to the axial direction of the push rod, the cover cases are provided with openings.

7. The push rod assembly according to claim 6, wherein along an arrangement direction of two cover cases, each cover case is provided with one opening on a side facing away from another cover case.

8. The push rod assembly according to claim 7, wherein the cover case comprising:
two first plate bodies, the two first plate bodies are oppositely arranged, and an arrangement direction of the two first plate bodies is perpendicular to the axial direction of the push body and the length direction of the auxiliary movable contact piece;
a second plate body, along the length direction of the auxiliary movable contact piece, the second plate body connects to ends of the two first plate bodies facing the main body;
a top plate, the top plate connects to the two first plate bodies and the second plate body, to form a chamber for accommodating the auxiliary movable contact; the top plate and two first plate bodies form openings on sides facing away from the main body.

9. The push rod assembly according to claim 6, wherein the openings on the two cover cases are arranged along a diagonal of the isolation cover, and the main body cooperates with each house to form an opening.

10. The push rod assembly according to claim 9, wherein the cover case comprising a first plate body and a second plate body, wherein:
the first plate body connects to the main body, and an extending direction of the first plate body is perpendicular to an axial line of the push rod;
the second plate body extends from the first plate body, and an extending direction of the second plate body is perpendicular to an extending direction of the first plate body, the second plate body is provided with the openings.

11. The push rod assembly according to claim 3, wherein the push rod assembly further comprises a contact bracket, the contact bracket connects to the isolation cover, and the contact bracket follows the push rod.

12. The push rod assembly according to claim 11, wherein the contact bracket is connected to the push rod, the auxiliary movable contact part and the isolation cover by integral injection molding.

13. The push rod assembly according to claim 11, wherein the contact bracket comprises a bottom plate, an upper plate and two side plates arranged oppositely, along the axial direction of the push rod, two side plates are located on a same side of the bottom plate, and the upper plate is connected to another end of the two side plates facing away from the bottom plate.

14. The push rod assembly according to claim 13, wherein the isolation cover further comprises two extending structures, along an arrangement direction of the two side plates, two extending structures extend from the opposite sides of the main body; each extending structure extends away from the push rod, and each extending structure wraps one end of the side plate near the main body.

15. The push rod assembly according to claim 14, wherein a connecting structure is provided between the cover case and the extending structure adjacent to the cover case, the connecting structure connects to the cover case and the main body and/or the extending structure, to block the gap between the cover case and the main body and/or the extending structure.

16. The push rod assembly according to a claim 3, wherein along an axial direction of the push rod, a spring member is installed at a side of the isolation cover facing away from the push rod.

17. The push rod assembly according to claim 16, wherein along the axial direction of the push rod, an isolation blocking wall is provided at a side of the main body facing away from the push rod, the isolation blocking wall extends from a surface of the main body facing away from the push rod; and along a radial direction of the push rod, the isolation blocking wall is arranged at at least one side of the spring member.

18. The push rod assembly according to claim 1, wherein the isolation cover connects to the push rod and the auxiliary movable contact part by integral injection molding.

19. A relay, comprising a push rod assembly according to claim 1.

20. The relay according to claim 19, wherein further comprises a yoke plate and an auxiliary lead-out piece, the auxiliary lead-out piece and the push rod of the push rod assembly runs through the yoke plate, the auxiliary lead-out piece is provided with an auxiliary static contact corresponding to the auxiliary movable contact at a side of the yoke plate facing the auxiliary movable contact part.

21. A method for manufacturing push rod assembly, wherein by adopting an injection molding process, a push rod and an auxiliary movable contact part are connected to form an isolation cover, and the isolation cover covers an auxiliary movable contact of the auxiliary movable contact part.

22. A method for manufacturing push rod assembly, wherein comprising:
by adopting an injection molding process, forming a first structural member at preset positions of a push rod and an auxiliary movable contact part, and the push rod and the auxiliary movable contact part are connected through the first structural member; and
by adopting an injection molding process again, making a second structural member on a surface of the first structural member to form an isolation cover; wherein, the isolation cover covers an auxiliary movable contact of the auxiliary movable contact part to isolate the auxiliary movable contact from a main movable contact part; and the isolation cover is configured to extend a creepage distance from the main movable contact part to the auxiliary movable contact part.

23. The method for manufacturing push rod assembly according to claim 22, wherein the method for by adopting an injection molding process forming a first structural member at preset positions of a push rod and an auxiliary movable contact part, further comprising:
providing a contact bracket; and
forming the first structural member at preset positions of an axial end of the push rod, the auxiliary movable contact part and the contact bracket by adopting an injection molding process.
